(19) United States
(12) Patent Application Publication
(10) Pub. No.: US 2002/0103974 A1
(43) Pub. Date: Aug. 1, 2002

(54) Method and apparatus for economical cache population

(76) Inventors: Peter Joseph Giacomini, South Plainfield, NJ (US); Walter Michael Pitio, Morganville, NJ (US); Hector Francisco Rodriguez, Middletown, NJ (US); Donald David Shugard, Middletown, NJ (US)

Correspondence Address: JASON PAUL DEMONT, DEMONT & BREYER LLC, PO BOX 7490, SHREWSBURY, NJ, 07702, US

(21) Appl. No.: 09/725,737

(22) Filed: Nov. 29, 2000

(51) Int. Cl. G06F 12/00

(52) U.S. Cl. 711/133; 711/202

(57) ABSTRACT

A technique for efficiently populating a cache in a data processing system with resources is disclosed. In particular, a node in accordance with the illustrative embodiment of the present invention defers populating its cache with a resource until at least two requests for the resource have been received. This is advantageous because it prevents the cache from being populated with infrequently requested resources. Furthermore, the illustrative embodiment of the present invention populates a cache with a resource only when: at least i requests for the resource have been received at a given node within an elapsed time interval, Δt, wherein i is an integer greater than one; and at least one request for the resource has been received from at least n of the m filial nodes of the given node within an elapsed time interval, Δt, wherein m is an integer greater than one, n is an integer greater than one, and m≧n. Embodiments of the present invention are particularly advantageous in computer networks that comprise a logical hierarchical topology, but are useful an any computer network, and in individual data processing systems and routers that comprise a cache memory.

### REFERENCE TO RELATED APPLICATIONS

This application is related to U.S. patent application Ser. No. ______, entitled “Distributed Caching Architecture For Computer Networks,” (Attorney Docket “Broadspider 1”) filed on the same date as this application, which is incorporated by reference.

### FIELD OF THE INVENTION

The present invention relates to data processing systems and computer networks in general, and, more particularly, to techniques for caching resources in cache.

### BACKGROUND OF THE INVENTION

When a user of the World Wide Web requests a Web page, the user must wait until the page is available on his or her data processing system (e.g., computer, etc.) for viewing. In general, this wait occurs because the request for the Web page must traverse the Internet from the user's data processing system to the data processing system that is the source of the page, the request must be fulfilled, and the requested page must travel back to the user's system. If the Internet is congested or the data processing system that is the source of the page is overwhelmed with many concurrent requests for pages, the wait can be considerably long.

To shorten this wait, special data processing systems are deployed throughout the Internet that expedite the delivery of some Web pages. Some of these data processing systems expedite the delivery of Web pages by functioning as cache memories, which are also known as “caches.” For the purpose of this specification, a “cache” is defined as a cache memory. For example, a cache stores commonly requested Web pages and thereafter enables requests for those pages to be intercepted and fulfilled from the cache without retrieval from the principal memory. This expedites the delivery of the Web page in two ways. First, a cache eliminates the need for the request to travel all of the way to the system that is the ultimate source of the page, and, therefore, eliminates some of the wait associated with the transit. Second, a cache also reduces the number of Web page requests that must be fulfilled by the system that is the ultimate source of the page, and, therefore, the wait associated with contention for the system is eliminated.

FIG. 1 depicts a block diagram of a computer network in the prior art in which one of the network's nodes acts as a cache for another of the nodes. Computer network 100 comprises three nodes that are interconnected logically as shown. The salient characteristic of the topology of computer network 100 is that node 121 communicates with node 101 only through node 111, and, therefore, node 111 is capable of intercepting and fulfilling requests from node 121 for node 101. In other words, although there might be more than one physical telecommunication path between node 101 and node 111 (not shown in FIG. 1) and more than one physical telecommunication path between node 111 and node 121 (also not shown in FIG. 1), and even a direct physical telecommunication path between node 101 and 121, node 111 is logically in the path between node 101 and node 121.

From the perspective of node 121 and node 111, node 101 actually or apparently comprises a vast amount of information arranged in bundles, called “resources.” For the purposes of this specification, a “resource” is defined as an individually addressable bundle of information that can be requested by a node. For example, a resource might be an individual computer file (e.g., a World Wide Web page, a .gif file, a Java script, etc.) or a database record, etc. Although node 101 can actually comprise a vast amount of information if, for example, it is a disk farm, it can also apparently comprise the information if it acts as a gateway to a data network, such as the Internet.

When node 101 is bombarded with a large number of concurrent requests for resources from node 121, node 101 might not be able to instantaneously respond to all of the requests. Therefore, to reduce the average delay between when node 121 requests a resource from node 101 and when it receives the resource, node 111 functions as a cache for node 101.

FIG. 2 depicts a block diagram of the salient components of node 111 in accordance with the prior art. Node 111 comprises: processor 201, memory 202, receiver 210, transmitter 211, transmitter 213, and receiver 214. Processor 201 is typically a general-purpose processor or a special-purpose processor that performs the functionality described herein with respect to FIG. 3. Memory 202 holds programs and data for processor 201 and comprises cache 203, which holds the cached resources for node 101. Node 111 uses receiver 210 for receiving data from node 121, transmitter 211 for transmitting to node 121, transmitter 213 for transmitting to node 101, and receiver 214 for receiving from node 121.

FIG. 3 depicts a flowchart of the operations performed by node 121 and node 111 when node 121 requests a resource from node 101 and node 111 intercepts the request, acts a cache for node 101, and fulfills the request, if possible, or passes the request on to node 101, if necessary.

At step 301, node 121 receives a resource identifier and a request for the resource. This request and resource identifier might, for example, originate with a user of node 121 as part of a World Wide Web browsing session (e.g., http://www.amazon com/mccullers.htm, etc.).

At step 302, node 121 transmits: (i) the resource identifier, and (ii) a request for the resource to node 111, and at step 303, node 111 receives: (i) the resource identifier, and (ii) a request for the resource.

At step 305, node 111 determines if, in fact, the requested resource is in its cache data structure. If it is (i.e., a cache “hit”), then control passes to step 309; otherwise (i.e., a cache “miss”) control passes to step 306.

At step 306, node 111 transmits the resource identifier and request for the resource identifier to node 101, and at step 307 node 111 receives the requested resource.

At step 308, node 111 populates its cache with the received resource so that the next time the resource is requested, node 111 can fulfill the request itself. If the cache does not have enough empty storage available for the resource, node 111 can delete other resources in the cache, in accordance with any of many well-known cache replacement algorithms, to make room for the most recently requested resource.

At step 309, node 111 transmits the resource to node 121, as requested, whether the requested resource was in node 111's cache data structure or not.

The increasing size and complexity of the Internet, and its increasing use for transmitting multimedia resources has created the need for improved caching techniques.

### SUMMARY OF THE INVENTION

The present invention is a technique for efficiently populating a cache with resources that avoids some of the costs and disadvantages associated with caching techniques in the prior art. In particular, a node in accordance with the illustrative embodiment of the present invention defers, at least occassionally, populating its cache with a resource until at least two requests for the resource have been received. This is advantageous because it prevents the cache from being populated with infrequently requested resources.

Furthermore, the illustrative embodiment of the present invention populates a cache with a resource only when:

1. at least i requests for the resource have been received at a given node within an elapsed time interval, Δt, wherein i is an integer greater than one; and

2. at least one request for the resource has been received from at least n of the m filial nodes of the given node within an elapsed time interval, Δt, wherein m is an integer greater than one, n is an integer greater than one, and m≧n.

Embodiments of the present invention are particularly advantageous in computer networks that comprise a logical hierarchical topology, but are useful an any computer network, and in individual data processing systems and routers that comprise a cache memory.

The illustrative embodiment of the present invention comprises populating a cache with a resource only when at least i requests for said resource have been received, wherein i is an integer greater than one.

### BRIEF DESCRIPTION OF THE DRAWINGS

FIG. 1 depicts a block diagram of a computer network in the prior art.

FIG. 2 depicts a block diagram of the salient components of one of the nodes depicted in FIG. 1.

FIG. 3 depicts a flowchart of the operations performed by two of the nodes depicted in FIG. 1.

FIG. 4 depicts a block diagram of the illustrative embodiment of the present invention.

FIG. 5 depicts a block diagram of the salient components of a data processing node in accordance with the illustrative embodiment of the present invention.

FIG. 6 depicts a flowchart of the illustrative embodiment of the present invention.

FIG. 7 depicts a graph of the average latency as a function of i, in accordance with the illustrative embodiment of the present invention.

FIG. 8 depicts a graph of the cache storage needs as a function of i, in accordance with the illustrative embodiment of the present invention.

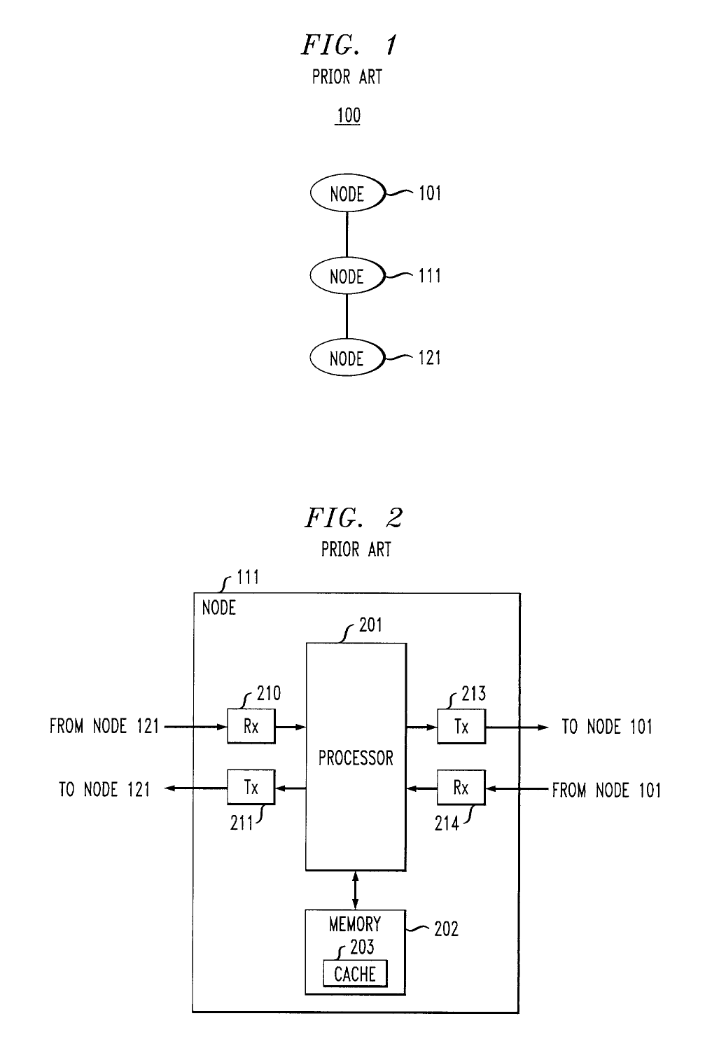

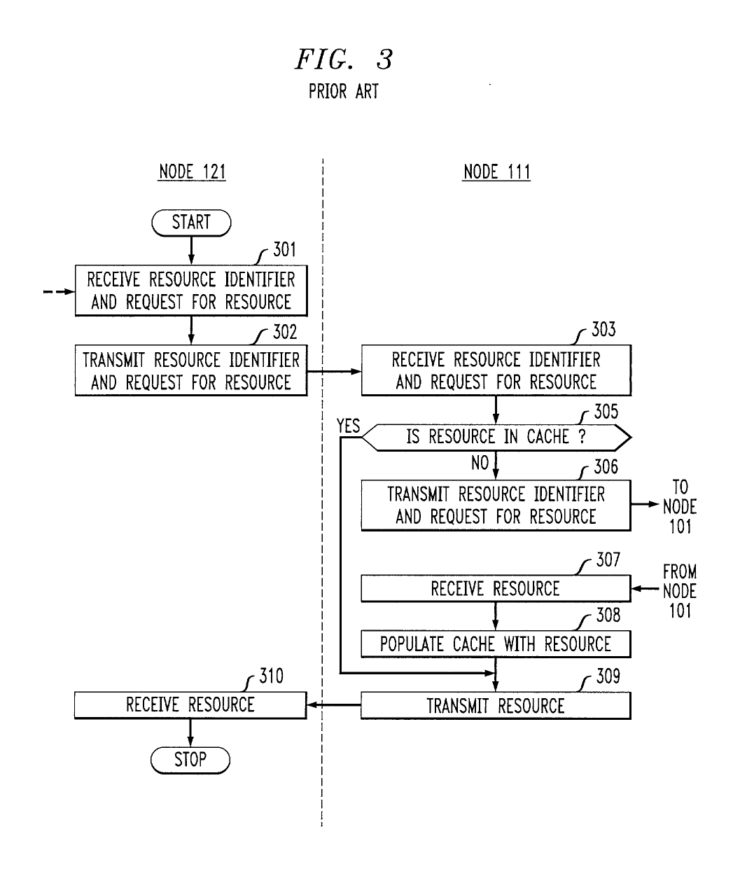

### DETAILED DESCRIPTION

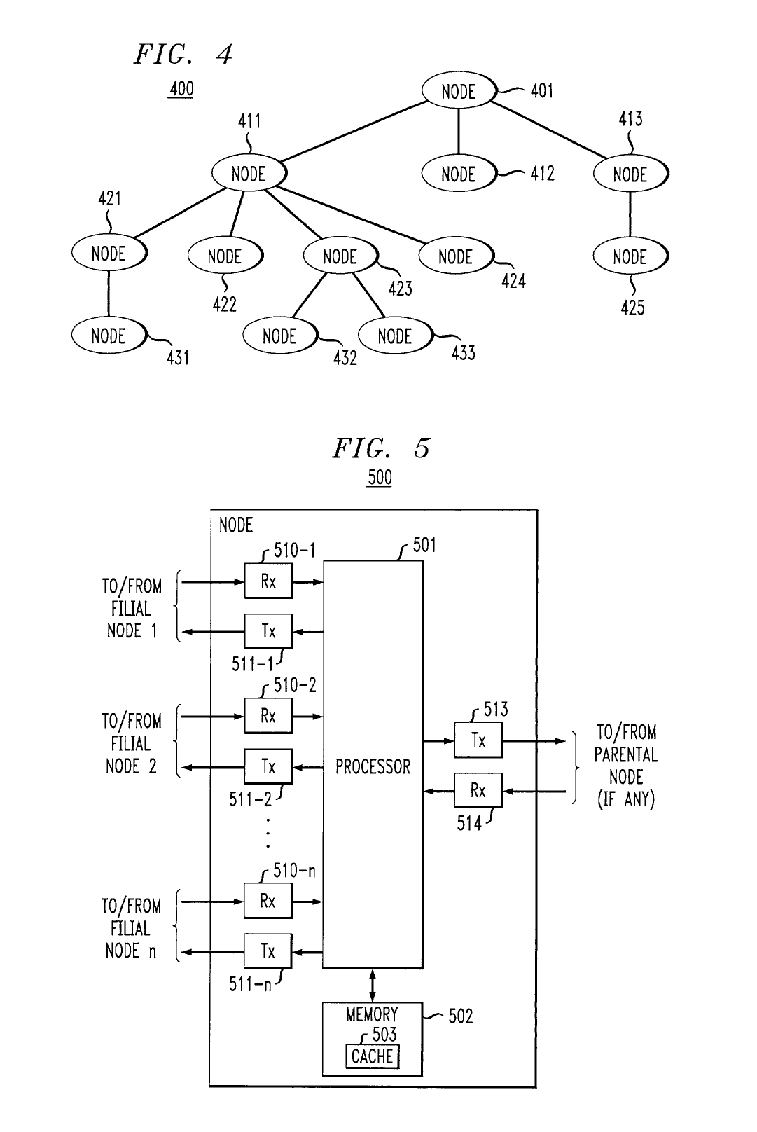

FIG. 4 depicts a block diagram of the illustrative embodiment of the present invention, which comprises 12 nodes (i.e., data processing systems) that are interconnected in a computer network with a logical hierarchical topology. In other words, although there might be one or more physical telecommunication links (not shown) between any two nodes depicted in FIG. 4, the nodes are interrelated in a logical hierarchy. This point is worth reiterating; the depicted paths between the nodes in FIG. 4 represent the logical hierarchical relationship of the nodes and not the physical telecommunication links that the nodes use to communicate with each other. Therefore, the illustrative embodiment is well-suited for networks with dynamic routing (e.g., Internet Protocol networks, etc.).

Although the illustrative embodiment comprises 12 data processing nodes in one particular hierarchy, it will be clear to those skilled in the art how to make and use embodiments of the present invention that comprise any number of nodes that are interconnected in any hierarchy. Furthermore, it will be clear to those skilled in the art how the inventions described herein are useful in any computer network with any logical topology—including those that are not hierarchical—and also to individual data processing systems and routers that comprise a cache memory.

In accordance with the illustrative embodiment of the present invention, each pair of interconnected nodes communicate with each other, either directly or indirectly, via one or more physical wireline or wireless telecommunications links or both (not shown in FIG. 4). It will be clear to those skilled in the art how to make and use such telecommunications links. For the purposes of this specification, the term “path” refers to the logical communication between the nodes and not to the physical telecommunications links between the nodes.

Because the illustrative embodiment has a hierarchical topology, several terms relating to hierarchies are defined so as to facilitate an unambiguous description of the illustrative embodiment. Therefore, for the purpose of this specification:

a “hierarchical computer network” is defined as a computer network in which there is only one logical communication path between any two nodes in the network, and one of the nodes in the network is designated as the “root.”

a “given node” is any node in a computer network.

the “ancestral nodes” of a given node are defined as all of the nodes, if any, logically between the given node and the root, including the root. For example, the ancestral nodes of node 423 are nodes 411 and 401. One corollary of this definition is that the root has no ancestral nodes, but all other nodes have at least one ancestral node (the root).

the “parental node” of a given node is defined as only that node, if any, adjacent to the given node and in the logical path between the given node and the root. For example, the parental node of node 423 is node 411 and the parental node of node 411 is node 401. One corollary of this definition is that the root has no parental node. A second corollary is that all of the nodes in the hierarchy except the root have exactly one parental node. A third corollary of this definition is that a parental node of a given node is also an ancestral node of the given node, but an ancestral node of a given node might be, but is not necessarily a parental node of the given node.

the “grandparental node” of a given node is defined as only that node, if any, adjacent to the parental node of the given node and in the logical path between the given node and the root. For example, the grandparental node of node 432 is node 411, and the grandparental node of node 425 is node 401.

the “lineal nodes” of a given node are defined as all of the nodes, if any, that must communicate through the given node to communicate with the root. For example, the lineal nodes of node 411 are nodes 421, 422, 423, 424, 431, 432, and 433. One corollary of this definition is that all of the nodes other than the root are lineal nodes of the root.

the “filial nodes” of a given node are defined as all of the nodes, if any, that must communicate through the given node to communicate with the root and that are adjacent to the given node. For example, the filial nodes of node 411 are nodes 421, 422, 423, and 424. One corollary to this definition is that a filial node of a given node is also a lineal node of the given node, but a lineal of a given node might be, but is not necessarily a filial node of the given node.

the “leaves” of a hierarchy are defines as those nodes that do not have any filial nodes. For example, the leaves in the illustrative embodiment are nodes 412, 422, 424, 425, 431, 432, and 433.

In accordance with the illustrative embodiment, root node 401 actually or apparently comprises a vast amount of information, arranged in bundles called “resources,” that are individually addressable and that can be individually requested by some or all of the nodes in hierarchical network 400. For example, root node 401 can be a disk farm or a gateway to a data network (not shown in FIG. 4), such as the Internet, that itself comprises some or all of the resources. In accordance with the illustrative embodiment, each resource is a file (e.g., a World Wide Web page, a gif file, a Java script, etc.). It will be clear to those skilled in the art how to make and use embodiments of the present invention in which a resource is something other than a file.

For the purposes of this specification, a “resource identifier” is defined as the indicium of a resource. In accordance with the illustrative embodiment, each resource identifier is a uniform resource locator (e.g., www.amazon.com/books/102-8956393, etc.), which is commonly called a “URL.” It will be clear to those skilled in the art how to make and use embodiments of the present invention in which a resource identifier is something other than a URL.

In accordance with the illustrative embodiment of the present invention, some or all of the nodes in the illustrative embodiment generate requests for resources that are originally available via root node 401. Some of these requests might be instigated by a user associated with a node and some of the requests might be instigated by a node itself. Typically, the leaf nodes are the nodes that originally generate the requests because the leaf nodes are typically those that interact most often with end-users.

Because root node 401 might be bombarded with many concurrent requests for resources, it is typically not able to instantaneously provide a requested resource. And because any delay between the time when a node requests a resource and when the node receives the resource is generally undesirable, the illustrative embodiment advantageously incorporates caches for reducing the average delay. In accordance with the illustrative embodiment of the present invention, each node advantageously acts as a cache for its lineal nodes.

FIG. 5 depicts a block diagram of the salient components of a data processing node in accordance with the illustrative embodiment of the present invention. Each data processing node comprises: processor 501, memory 502, cache 503, transmitter 513, receiver 514, receivers 510-1 through 510-n, and transmitters 511-1 through 511-n.

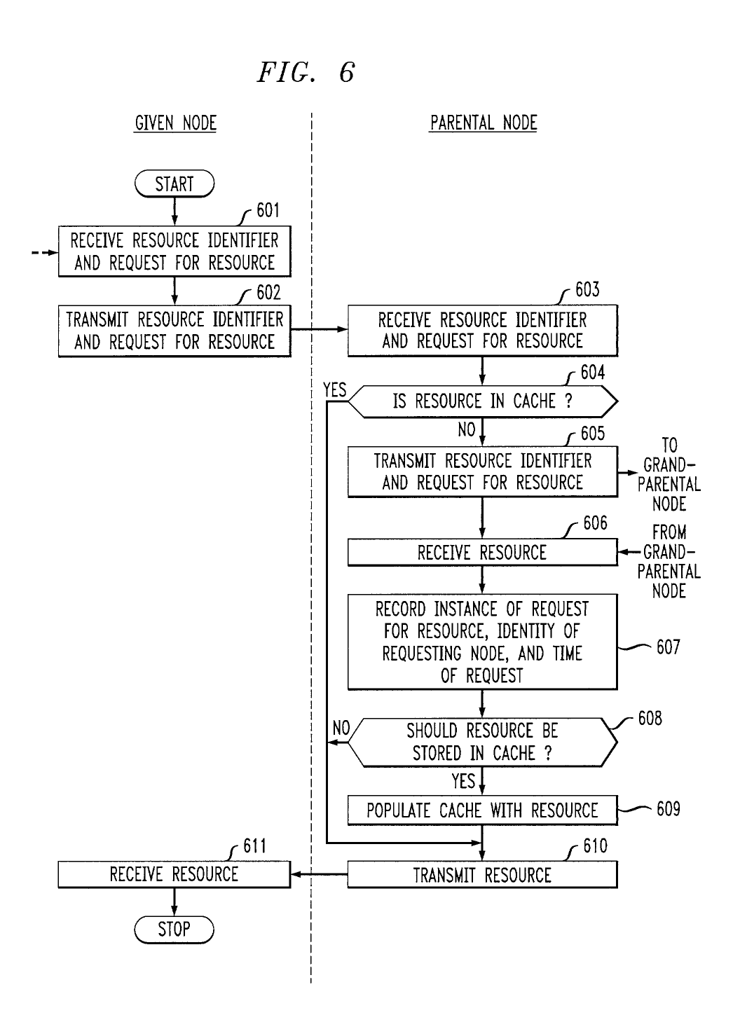

Processor 501 is advantageously a general-purpose processor or a special-purpose processor that performs the functionality described herein and with respect to FIG. 6. Memory 502 holds programs and data for processor 501, and cache 503. It will be clear to those skilled in the art that memory 502 can utilize any storage technology (e.g., semiconductor RAM, magnetic hard disk, optical disk, etc.) or combination of storage technologies, and it will also be clear to those skilled in the art that memory 502 can comprise a plurality of memories, each of which has different memory spaces.

All nodes, including root node 401 if it is a gateway to a data network, comprise: transmitter 513 for transmitting data to its parental node (or to the data network in the case of the root node) and receiver 514 for receiving data from its parental node (or from the data network in the case of the root node). It will be clear to those skilled in the art how to make and use transmitter 513 and receiver 514.

All nodes, except the leaves, comprise: one or more receivers 510-i and one or more transmitters 511-i for communicating with each of the node's n filial nodes, where i=1 to n. It will be clear to those skilled in the art how to make and use receivers 510-1 through 510-n and transmitters 511-1 through 511-n.

FIG. 6 depicts a flowchart of the operation of the illustrative embodiment of the present invention, in which a given node, hereinafter called the “Given Node,” requests a resource from its parental node, hereinafter called the “Parental Node,” which resource might be in the Parental Node's cache or if not will need to be requested and received from the parental node of the Parental Node, which is called the “Grandparental Node.”

At step 601, the Given Node receives a resource identifier and a request for the resource. This request and resource identifier might, for example, originate with a user of the Given Node as part of a World Wide Web browsing session (e.g., http://www.amazon.comlmccullers.htm, etc.). As another example, the request and resource identifier can originate with a lineal node of the Given Node, in which case the Given Node might retrieve the resource and store it and its resource identifier in its own cache.

At step 602, the Given Node transmits:

i. the resource identifier, and

ii. a request for the resource

to the Parental Node.

At step 603, the Parental Node receives:

i. the resource identifier, and

ii. a request for the resource

from the Given Node. It should be understood that the request for the resource can be either explicit or implicit. For example, an explicit request might comprise a command code that accompanies the resource identifier and that is to be interpreted as a request for the resource associated with the resource identifier. Alternatively, an implicit request might be assumed whenever the Parental Node merely receives a resource identifier from the Given Node.

At step 604, the Parental Node uses the resource identifier as an index into cache 503 to determine if the resource is contained in the Parental Node's cache. Alternatively, as taught in applicants' co-pending U.S. patent application Ser. No. ______, entitled “Distributed Caching Architecture For Computer Networks,” the Parental Node can use a hashed function of the resource identifier as the index into cache 503. In either case, if the requested resource is in cache 503 (i.e., a cache hit), then control passes to step 610; otherwise (i.e., a cache “miss”) control passes to step 605.

At step 605, the Parental Node begins the process, which is completed in step 606, of retrieving the requested resource from its parental node, the Grandparental Node. Advantageously, the Parental Node retrieves the requested resource from its parental node in the same manner that the Given Node did from the Parental Node. In other words, step 605 for the Parental Node is identical to step 602 for the Given Node in that the Parental Node advantageously transmits:

i. the resource identifier,

ii. a request for the resource to the Grandparental Node. In this way, steps 602 through 611 in FIG. 6 are recursive up through the hierarchy until the requested resource is found.

At step 606, the Parental Node receives the requested resource from the Grandparental Node.

At step 607 the Parental Node records:

i. the instance of the request from the Given Node for the resource,

ii. the identity of the Given Node to distinguish it from the Parental Node's other filial nodes, and

iii. the time of the instance of the request from the Given Node,

in a data structure, such as that shown in Table 1.

TABLE 1
Illustrative Data Structure For Maintaining A Record of Each Request

| Resource Identifier | Requesting Node ID | Time Stamp |
|---|---|---|
| . . . | . . . | . . . |
| www.amazon.com/mccullers.htm | Node #34 | 10:34 GMT |
| | | Aug. 24, 2000 |
| www.amazon.com/books.htm | Node #238 | 21:11 GMT |
| | | Aug. 15, 2000 |
| www.amazon.com/sales.htm | Node #238 | 11:06 GMT |
| | | Aug. 23, 2000 |
| . . . | . . . | . . . |

The purpose of recording this information is to enable the Parental Node, at step 608, to determine when and if the resource received in step 606 should be stored in cache 503.

At step 608, the Parental Node determines whether the resource received in step 606, which is not currently in the Parental Node's cache, should be stored in cache 503. There are several factors that the Parental Node considers.

First, the Parental Node only populates cache 503 with the resource when at least i requests for the resource have been received, wherein i is a positive integer. In other words, the illustrative embodiment won't store the resource in the Parental Node's cache unless at least i requests for the resource have been received within an elapsed time interval, Δt. In some cases, the value of i is one, and in other cases the value of i is an integer greater than one.

In some cases, the value of i is invariant (i.e., it does not change over time or as a function of circumstance). Alternatively, the value of i varies and is based on:

i. the calendrical time, or

ii. the elapsed time interval, Δt, or

iii. the number, m, of filial nodes of the Parental Node, or iv. any combination of i, ii, and iii.

For the purposes of this specification, the phrase “calendrical time” is defined as the time with respect to the calendar. For example, the value of i can vary with the time of day, the day of the week, the day of the month, the day of the year, the month of the year, the season of the year, the year itself, etc. Table 2 depicts an illustrative embodiment of the present invention in which the value of i varies as a function of the day of the week.

TABLE 2
Illustrative Embodiment in Which i is a Function of the Day of the Week

| Day of the Week | i |
|---|---|
| Sunday | 2 |
| Monday | 3 |
| Tuesday | 1 |
| Wednesday | 4 |
| Thursday | 3 |
| Friday | 1 |
| Saturday | 2 |

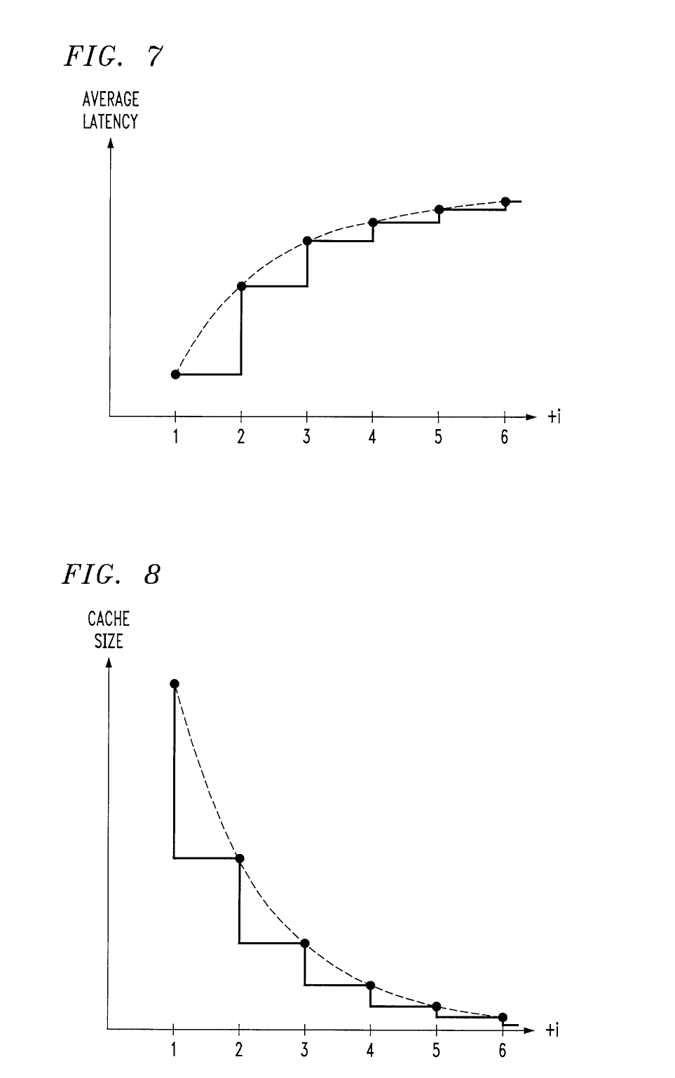

The Parental Node can determine how many total requests there have been for a resource by using the data the Parental Node stored in step 607. As will be clear to those skilled in the art, varying the value of i as a function of the calendrical time has several effects on the operation of the illustrative embodiment. First, as shown in FIG. 7, the average amount of time that a given node must wait for a requested resource increases as i increases, but, as shown in FIG. 8, the storage requirements for cache 503 in the Parental Node decrease as i increases. Therefore, varying the value of i as a function of the calendrical time provides a parameter for controlling the operation of some embodiments of the present invention.

Second, the Parental Node only populates cache 503 with the resource when at least i requests for the resource have been received within an elapsed time interval, Δt. In other words, the illustrative embodiment won't store the resource in the Parental Node's cache unless at least a plurality of requests for the resource have been received within some time interval, Δt. In some cases, the value of Δt can be invariant.

Alternatively, the value of Δt can vary and can be based on:

i. the value of i, or

ii. the calendrical time, or

iii. the number, m, of filial nodes of the Parental Node, or

iv. any combination of i, ii, and iii.

Table 3 depicts an illustrative embodiment of the present invention in which the value Δt varies as a function of the value of i.

TABLE 3
The Value of Δt Varies Based On The Value of i

| i | Δt |
|---|---|
| 2 | 24 minutes |
| 3 | 150 minutes |
| 4 | 350 minutes |
| 5 | 1000 minutes |
| 6 | 2400 minutes |
| >7 | 6000 minutes |

Furthermore, both i and Δt can vary and can be based on the calendrical time. Table 4 depicts an illustrative embodiment of the present invention in which the values of i and Δt vary as a function of the time of day.

TABLE 4
The Value of i and Δt Vary Based On Calendrical Time

| Time of Day | i | Δt |
|---|---|---|
| Midnight to 5:30 AM | 2 | 300 minutes |
| 5:30 AM to 9:00 AM | 3 | 150 minutes |
| 9:00 AM to 4:30 PM | 3 | 75 minutes |
| 4:30 PM to Midnight | 4 | 100 minutes |

The Parental Node can determine when each request for a resource have been made, and therefore if the requisite number of requests have been made in the elapsed time interval, Δt, by using the using the data the Parental Node has stored in step 607.

Third, the Parental Node only populates cache 503 with the resource when at least one request for the resource has been received from at least n of the Parental Node's m filial nodes. This is advantageous because it prevents the cache from being populated with resources that are only being used by a few of the Parental Node's filial nodes. In some cases, the value of n can be invariant.

Alternatively, the value of n can vary based on:

i. the value of m, or

ii. the value of i, or

iii. the elapsed time interval, Δt, or

iv. the calendrical time,

v. any combination of i, ii, iii, and iv.

The Parental Node can determine how many of the Parental Node's m filial nodes have requested the resource by using the using the data the Parental Node has stored in step 607.

As part of step 608, if the Parental Node determines that the resource should be stored in cache 503, then control passes to step 609; otherwise, control passes to step 610.

At step 609, the Parental Node populates its cache with the resource with the resource identifier (or a hash function of the resource identifier) as the index.

At step 610, the Parental Node transmits the resource to the Given Node, and at step 611, the Given Node receives the resource.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
populating a cache with a resource only when at least i requests for said resource have been received;
wherein at least occassionally i is an integer greater than one.

2. The method of claim 1 wherein the value of i is invariant.

3. The method of claim 1 wherein the value of i is based on calendrical time.

4. The method of claim 1 wherein said cache is populated with said resource only when at least i requests for said resource have been received within an elapsed time interval, Δt.

5. The method of claim 4 wherein the duration of said elapsed time interval, Δt, is based on the value of i.

6. The method of claim 4 wherein the value of i is based on calendrical time.

7. The method of claim 4 wherein the duration of said elapsed time interval, Δt, is based on calendrical time.

8. A data processing system comprising:
a cache for storing a resource; and
a processor for populating said cache with said resource only when at least i requests for said resource have been received;
wherein i is an integer greater than one.

9. The data processing system of claim 8 wherein the value of i is invariant.

10. The data processing system of claim 8 wherein the value of i is based on calendrical time.

11. The data processing system of claim 8 wherein said cache is populated with said resource only when at least i requests for said resource have been received within an elapsed time interval, Δt.

12. The data processing system of claim 8 wherein the duration of said elapsed time interval, Δt, is based on the value of i.

13. The data processing system of claim 8 wherein the value of i is based on calendrical time.

14. The data processing system of claim 8 wherein the duration of said elapsed time interval, Δt, is based on calendrical time.

15. A method comprising:
receiving at a first node in a computer network at least one request for a resource;
retrieving said resource from a second node in said computer network; and
populating a cache in said first node with said resource only when at least i requests for said resource have been received at said first node;
wherein i is an integer greater than one.

16. The method of claim 15 wherein the value of i is invariant.

17. The method of claim 15 wherein the value of i is based on calendrical time.

18. The method of claim 15 wherein said cache is populated with said resource only when at least i requests for said resource have been received within an elapsed time interval, Δt.

19. The method of claim 18 wherein the duration of said elapsed time interval, Δt, is based on the value of i.

20. The method of claim 18 wherein the value of i is based on calendrical time.

21. The method of claim 18 wherein the duration of said elapsed time interval, Δt, is based on calendrical time.

22. The method of claim 15:
wherein said computer network is a hierarchical computer network and said first node has m filial nodes;
wherein said cache is populated with said resource only when at least one request for said resource has been received from at least n of said m filial nodes; and
wherein m is an integer greater than one, n is an integer greater than one, and m≧n.

23. The method of claim 15:
wherein said computer network is a hierarchical computer network and said first node has m filial nodes;
wherein said cache is populated with said resource only when at least one request for said resource has been received from at least n of said m filial nodes within an elapsed time interval, Δt; and
wherein m is an integer greater than one, n is an integer greater than one, and m≧n.

24. A first node in a computer network, said first node comprising:
a cache;
at least one receiver for receiving at least one request for a resource; and
a processor for retrieving said resource from a second node in said computer network, and for populating said cache in said first node with said resource only when at least i requests for said resource have been received at said first node;
wherein i is an integer greater than one.

25. The first node of claim 24 wherein the value of i is invariant.

26. The first node of claim 24 wherein the value of i is based on calendrical time.

27. The first node of claim 24 wherein said cache is populated with said resource only when at least i requests for said resource have been received within an elapsed time interval, Δt.

28. The first node of claim 27 wherein the duration of said elapsed time interval, Δt, is based on the value of i.

29. The first node of claim 27 wherein the value of i is based on calendrical time.

30. The first node of claim 27 wherein the duration of said elapsed time interval, Δt, is based on calendrical time.

31. The first node of claim 24:
wherein said computer network is a hierarchical computer network and said first node has m filial nodes;
wherein said cache is populated with said resource only when at least one request for said resource has been received from at least n of said m filial nodes; and
wherein m is an integer greater than one, n is an integer greater than one, and m >n.

32. The first node of claim 24:
wherein said computer network is a hierarchical computer network and said first node has m filial nodes;
wherein said cache is populated with said resource only when at least one request for said resource has been received from at least n of said m filial nodes within an elapsed time interval, Δt; and
wherein m is an integer greater than one, n is an integer greater than one, and m≧n.
